(19) United States
(12) Patent Application Publication
(10) Pub. No.: US 2011/0015804 A1
(43) Pub. Date: Jan. 20, 2011

(54) Vehicle Threshold Based Synchronous Communication System and Method

(75) Inventors: Charles A. Cluff, Zionsville, IN (US); Robert H. Obremski, Kokomo, IN (US); Mark R. Keyse, Sharpsville, IN (US)

Correspondence Address: Delphi Technologies, Inc., M/C 480-410-202, P.O. Box 5052, Troy, MI, 48007, US

(73) Assignee: DELPHI TECHNOLOGIES, INC., Troy, MI (US)

(21) Appl. No.: 12/504,939

(22) Filed: Jul. 17, 2009

(51) Int. Cl. G06F 7/00

(52) U.S. Cl. 701/1

(57) ABSTRACT

A system and method are provided for communicating data synchronously with a plurality of crash sensors onboard a vehicle. The system includes a control unit comprising interface circuitry for communicating with a plurality of crash sensors and providing synchronization signals to the crash sensors. The system also includes a communication bus coupled to the control unit for communicating with the crash sensors. The system further includes a plurality of crash sensors connected to the communication bus for communicating with the control unit. Each of the plurality of crash sensors receives one or more synchronization signals and is capable of transmitting data in response to the synchronous signals. The plurality of crash sensors each comprises logic for comparing a sensed parameter to a threshold and transmitting data when the sensed parameter exceeds the threshold. The logic further periodically transmits data based at least one of a time period and a synchronization count when the sensed parameter is less than the threshold.

### TECHNICAL FIELD

The present invention generally relates to vehicle communication systems and, more particularly relates to a synchronous communication system for communicating data between a control unit and a plurality of devices, such as sensors.

### BACKGROUND OF THE INVENTION

Automotive vehicles are commonly equipped with crash safety systems that detect a crash and deploy one or more devices in response to the detected crash. Such systems typically employ a plurality of restraint devices such as seatbelts that may lock or pretension, and air bags and curtains that may deploy at various locations in the passenger compartment of the vehicle. Additionally, such systems also include a plurality of crash sensors placed at strategic locations around the vehicle to acquire crash sensing information. The crash sensors are typically coupled to a central control unit by way of a communication bus. The sensed data is transmitted from the crash sensors to the central control unit which processes the information and typically makes decisions on whether to deploy one or more restraint devices.

Typical crash sensors generally transmit data in a serial format to the central control unit, and are generally configured to operate in either a synchronous data transmission mode or an asynchronous data transmission mode. Synchronous sensors transmit data in response to a synchronization signal that is sent from the central control unit to each of the sensors. Asynchronous sensors typically transmit data autonomously on a continuous or an as needed basis. Synchronous sensors typically are configured to operate in a bussed system architecture in which multiple sensors generally share a common communication link to the central control unit, or a non-bussed architecture in which individual sensors have a dedicated communication link to the central control unit and are generally not shared with other sensors.

In a typical synchronous communication system, the crash sensors receive the synchronization signals and, in response thereto, send data to the central control unit. In a typical crash sensing system, the transmission of data from the sensor to the central control unit occurs repeatedly at a very high rate of speed, such as a one millisecond cycle, since high speeds are necessary in order to timely detect vehicle crashes which occur very quickly. A typical crash sensor may include an accelerometer or pressure sensor which typically consumes approximately five milliamps of current when not transmitting, and twenty milliamps of average current when transmitting. As a consequence, the sensor consumes four times more energy to operate and transmit information as opposed to when not transmitting data. Thus, the rapid repeated transmission of data with a conventional sensor arrangement results in energy consumption which adds up over the life of the vehicle.

Accordingly, it is therefore desirable to provide for a vehicle crash sensing system which effectively transmits sensed data to the control unit while efficiently using energy.

### SUMMARY OF THE INVENTION

According to one aspect of the present invention, a system for communicating data synchronously with a plurality of devices on a vehicle is provided. The system includes a control unit comprising interface circuitry for communicating with devices, the control unit providing synchronization signals to the devices. The system also includes a communication bus coupled to the control unit for communicating with the devices. The system further includes a plurality of devices connected to the communication bus for communicating with the control unit. Each of the plurality of devices receives one or more of the synchronization signals transmitted by the control unit and is capable of transmitting data in response to the one or more synchronization signals. The plurality of devices each comprises logic for comparing a sensed parameter to a threshold and transmitting data to the control unit in response to receipt of the synchronization signal when the sensed parameter exceeds the threshold, wherein the logic further periodically transmits data based at least on one of a time period and a synchronization count value when the sensed parameter is less than the threshold.

According to another aspect of the present invention, a method of communicating data in a synchronous communication system having a plurality of devices on a vehicle is provided. The method comprises the steps of coupling a control unit to a plurality of devices onboard a vehicle, and communicating synchronization signals from the control unit to each of the plurality of devices via a communication bus. The method also includes the steps of sensing a parameter with each of the devices and generating a sensed output with each of the devices, comparing the sensed output of each device to a threshold and transmitting sensed data from the device to the control unit in response to receipt of the synchronization signal when the sensed output exceeds the threshold. The method further includes the steps of comparing at least one of a time period and a synchronization count to a count value and transmitting a message from the device to the control unit when the at least one of the time period and the synchronization count exceeds the count value.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a top schematic view of an automotive vehicle having a crash sensing system with an externally bussed vehicle architecture, according to one embodiment;

FIG. 2 is a schematic top view of the automotive vehicle equipped with a crash sensing system having an internally bussed vehicle architecture, according to another embodiment;

FIG. 3 is a block/circuit diagram illustrating the ECU internal connections for the internally bussed architecture of FIG. 2;

FIG. 4 is a block diagram illustrating a crash sensor of the system, according to one embodiment;

FIG. 5 is a flow diagram illustrating the transmit logic employed in a crash sensor, according to a first embodiment; and

FIG. 6 is a flow diagram illustrating the transmit logic employed in a crash sensor, according to a second embodiment.

### DESCRIPTION OF THE PREFERRED EMBODIMENTS

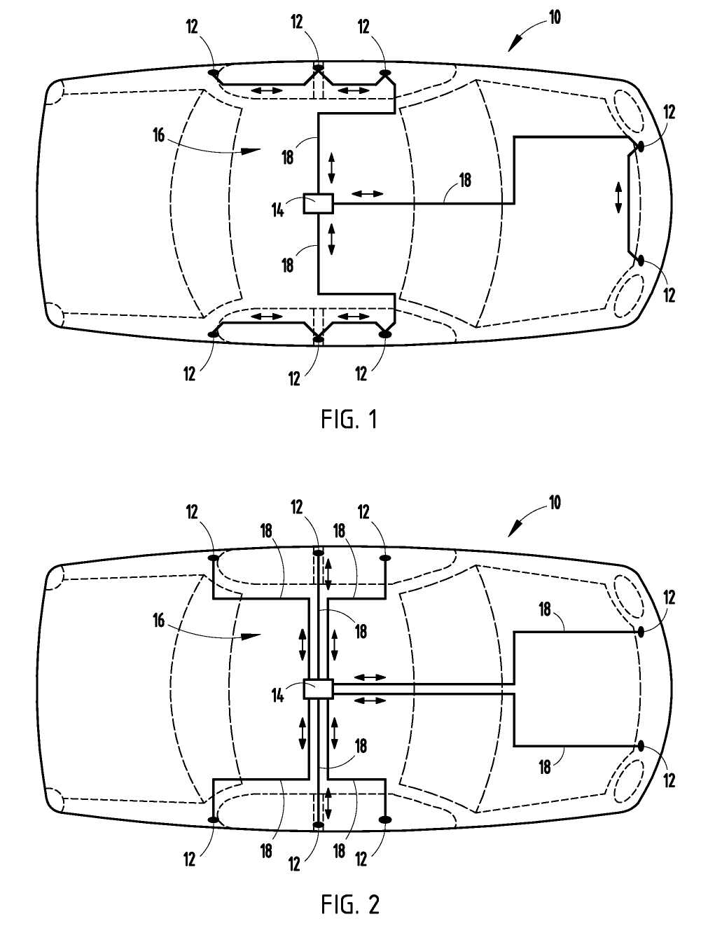

Referring to FIG. 1, automotive vehicle 10 is generally illustrated employing a system 16 that senses and detects a crash and deploys one or more crash responsive devices in response to detection of the crash. The system 16 includes a plurality of satellite devices shown and described herein as crash sensors 12 located at various locations on the vehicle 10 for sensing parameters and generating sensed parameter output signals. In a typical crash sensing system, the sensors 12 may include one or more accelerometers for sensing acceleration and deceleration, particularly that experienced during a vehicle crash. The sensors 12 may also include one or more pressure sensors for sensing pressure, particularly that experienced during a vehicle crash. It should be appreciated that sensors 12 may include other types of sensors, such as yaw sensors, roll sensors, pitch sensors and other sensors or devices. The various sensors 12 are shown located on opposite lateral sides of the vehicle 10, as well as near the front side of the vehicle 10, however, it should be appreciated that sensors 12 may be located by various other locations onboard the vehicle 10.

The crash sensing system 16 also includes an electronic control unit (ECU) 14 which is shown connected in communication with an externally bussed vehicle architecture having three communication buses 18, according to one example. Communication bus 18 may include a wire connection that connects each of the sensors 12 to the ECU 14 to allow data and message communication between each of sensors 12 and ECU 14. Communication bus 18 allows the ECU to transmit synchronization signals to each of the sensors 12 and allows each of the sensors 12 to transmit sensed data and messages to the ECU 14. In this embodiment, the vehicle communication bus 18 is externally bussed, relative to the ECU 14 such that the bus 18 has a single connection to the vehicle ECU 14 for a group of sensors 12. As shown, three sensors 12 are connected to a single connection that leads to the ECU 14, on each of the lateral sides of the vehicle 10 and two sensors are shown at the front of the vehicle 10 which lead to a common connection at the ECU 14.

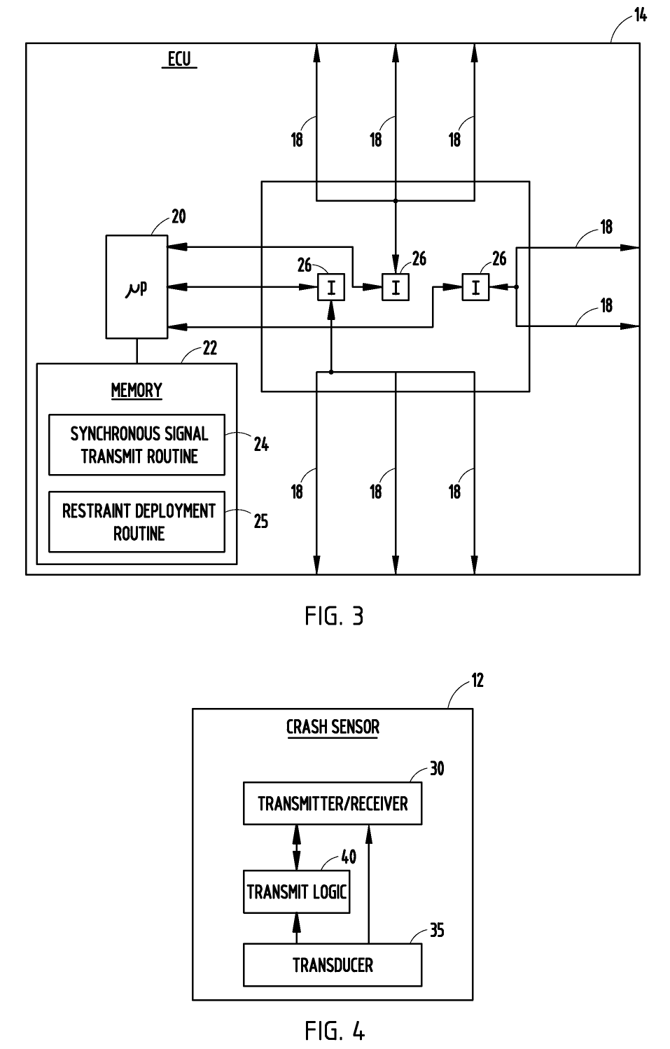

Referring to FIG. 2, the crash sensing system 16 is shown on a vehicle 10 that is illustrated having an internally bussed vehicle architecture, in contrast to the externally bussed architecture embodiment. In the internally bussed architecture embodiment, the communication bus 18 provides a unique connection between each sensor 12 and the ECU 14. The internally bussed architecture is similar to the externally bussed architecture in terms of electrical signal communication between the sensors 12 and ECU 14, however, the difference is the physical location of the connections between sensor channels on the same bus line. In this embodiment, the connections occur inside the ECU 14 which is further illustrated in FIG. 3.

As seen in FIG. 3, the electrical connections from each sensor 12 feed into the ECU 14 and are connected in groups to interface circuitry 26. Each block 26 represents interface circuitry for a single sensor bus which handles signal transmission for a plurality of sensors. The interface circuitry 26 provides a signal interface to enable signals to be transmitted between sensors 12 and ECU 14. The ECU 14 also has a microprocessor 20 and memory 22. The microprocessor 20 may include any control circuitry for generating the transmission of synchronous signals to each of the sensors 12 and for receiving and processing the sensed data received from each of the sensors 12. Memory 22 may include any memory storage medium, such as random access memory (RAM), read-only memory (ROM), electronically erasable programmable read-only memory (EEPROM), flash memory or other known memory storage medium. Stored within memory 22 is a synchronous signal transmit routine 24 for handling the transmission of synchronization signals, also referred to herein as sync signals, from the ECU 14 to each of the sensors 12. The synchronous signal transmit routine 24 essentially controls the timing and transmission of the synchronous signals that are sent to each sensor 12. One or more synchronous signals are sent to each sensor 12 to tell the sensor 12 that it is time to send any return data to the ECU 14. The synchronous signal transmit routine 24 may include a timing diagram that determines a time period for synchronizing communication with each sensor 12. Also stored in memory 22 is a restraint deployment routine 25 which may include any known deployment routine for deploying one or more devices, such as air bags, curtains, seatbelt pretensioners and other devices, onboard the vehicle 10. This may include processing the data received by each of the signals and determining whether or not a crash is imminent or about to occur with the vehicle 10, and deploying one or more restraint devices in response thereto.

Referring to FIG. 4, one crash sensor 12 is illustrated employing transmit logic 40 in accordance with the synchronous communication system. The crash sensor 12 is shown employing a transmitter/receiver 30 and transmit logic 40. According to one embodiment, the transmitter/receiver 30 and transmit logic 40 may be implemented with application specific integrated circuitry (ASIC). According to other embodiments, the transmitter/receiver 30 and transmit logic 40 may be implemented using the microprocessor and memory or other analog and/or digital circuitry. The transmitter/receiver 30 handles the transmission of signals from the crash sensor 12 to the ECU 14 and the receipt of synchronization signals from the ECU 14. The transmit logic 40 processes the synchronization signal, monitors the sensed parameters of the sensor 12, and generates the sensed parameters or messages to be transmitted to the ECU 14. The transmit logic 40 thereby controls the transmission of sensed data or messages from the crash sensor 12 to the ECU 14. Additionally, the crash sensor 12 is shown having a transducer 35, which may include a microelectromechanical systems (MEMS) transducer or other known sensing device for sensing one or more parameters. It should be appreciated that each of the crash sensors 12 may be configured as shown in FIG. 4.

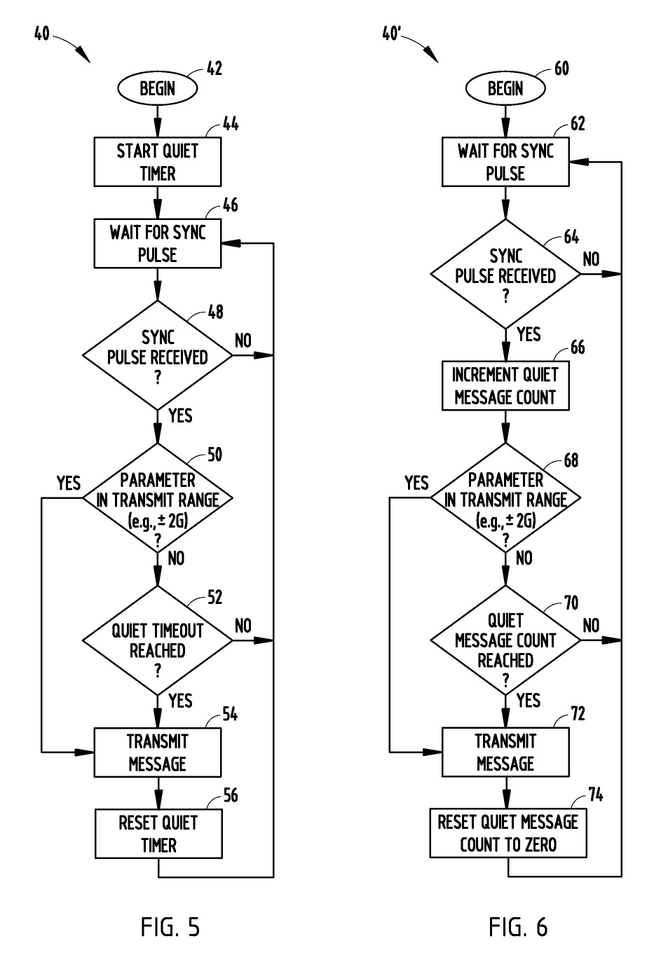

Referring to FIG. 5, the transmit logic 40 is illustrated according to one embodiment. Transmit logic 40 begins at step 42 and proceeds to start a quiet timer at step 44. Next, at step 46, routine 40 waits for a synchronization (sync) pulse. The sensor is expected to receive a sync pulse from the ECU at a predetermined cycle time period, such as every one millisecond, according to one embodiment. Routine 40 proceeds to a decision step 48 to determine if the sync pulse has been received, if not, waits for sync pulse at step 46. If a sync pulse has been received, routine 40 proceeds to decision step 50 to determine if the sensed parameter (e.g., acceleration, pressure, etc.) of the sensor is within a transmit range. The transmit range may include upper and lower thresholds, according to one embodiment and is indicative of establishing a minimum value of the sensed parameter sufficient to warrant transmission of the sensed data to the ECU 14. According to one example, for an accelerometer, the transmit range may employ threshold values of greater than +2 g or less than −2 g, which accounts for both sensed acceleration and deceleration values exceeding an absolute value of 2 g. If the absolute value of the sensed acceleration value is less than 2 g, the sensed value is considered to be of no value for the crash sensing system and the sensed parameter may be ignored, unless a timeout period has been reached. If the sensed parameter exceeds the transmit range (e.g., acceleration is greater than +2 g or less than −2 g), then the routine 40 transmits a message at step 54 which may include the transmission of the sensed data. If the parameter is not within the transmit range, routine 40 proceeds to decision step 52 to determine whether the quiet timeout period of the timer has been reached, which may be indicative of a quiet timer reaching a timeout threshold such as one second, for example. If the quiet timeout period has not been reached, routine 40 returns back to step 46 to wait for the next sync pulse. If the quiet timeout period has been reached at step 52, routine 40 then proceeds to transmit a message in step 54. It should be appreciated that the message transmitted at step 54 may include the data sensed by the sensor or may include another message sufficient to let the ECU know that the sensor is operating. Once the transmit message has been sent, routine 40 proceeds to reset the quiet timer in step 56 and returns to step 46 to wait for the next sync pulse.

Referring to FIG. 6, a transmit logic routine 40′ is illustrated according to a second embodiment. Routine 40′ begins at step 60 and proceeds to wait for the sync pulse at step 62. Decision step 64 determines whether the sync pulse has been received and, if not, waits for the new sync pulse to be received at step 62. Once a sync pulse has been received, routine 40′ proceeds to step 66 to increment a quiet message count. The quiet message count may be a counter that counts the number of sync pulses that are received. According to one embodiment, the sync pulses are received periodically based on time and, hence, are indirectly a measure of time. Next, at decision step 68, routine 40′ determines whether the sensed parameter is within the transmit range, such as an accelerometer having a value greater than 2 g or less than −2 g and, if so, transmits a message at step 72 which may include the sensed parameter. If the sensed parameter is not within the transmit zone, routine 40′ proceeds to decision step 70 to determine if the quiet message count has reached a count threshold. According to one example, a count threshold may include a value of one thousand, which, for an application having a sync transmit cycle of one millisecond, equates to a time period of about one second. If the quiet message count has been reached, routine 40′ transmits a message which may include the sensed data or other message at step 72, and then resets the quiet message count to zero at step 74. If the quiet message count has not been reached at step 70, routine 40′ returns back to step 62 to wait for the next sync pulse.

Accordingly, it should be appreciated that the crash sensing system 16 advantageously transmits sensed data when the data is worthy of transmission and periodically sends a transmit message based on a periodic time period or a count of sync pulses. The system 16 advantageously communicates the useful sensed data of the sensors 12 to the ECU 14 such that a decision can be made for deployment of one or more devices in a crash sensing and deployment system. The system 16 advantageously minimizes or reduces the number of transmissions that occur when there is no event, and therefore conserves on vehicle energy.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A system for communicating data synchronously with a plurality of devices on a vehicle, said system comprising:
a control unit comprising interface circuitry for communicating with devices, said control unit providing synchronization signals to the devices;
a communication bus coupled to the control unit for communicating with the devices; and
a plurality of devices connected to the communication bus for communicating with the control unit, wherein each of the plurality of devices receives one or more of the synchronization signals transmitted by the control unit and is capable of transmitting data in response to the one or more synchronization signals, wherein the plurality of devices each comprises logic for comparing a sensed parameter to a threshold and transmitting data to the control unit in response to receipt of the synchronization signal when the sensed parameter exceeds the threshold, wherein the logic further periodically transmits data to the control unit based at least on one of a time period and a synchronization count value when the sensed parameter is less than the threshold.

2. The system as defined in claim 1, wherein the devices comprise sensors.

3. The system as defined in claim 2, wherein the sensors comprise at least one accelerometer and the sensed parameter comprises sensed acceleration which is compared to an acceleration threshold.

4. The system as defined in claim 2, wherein the sensors comprise at least one pressure sensor and the sensed parameter comprises sensed pressure which is compared to a pressure threshold.

5. The system as defined in claim 2, wherein the sensors comprise crash sensors for use in a vehicle crash safety system.

6. The system as defined in claim 1, wherein the time period is based on a monitored clock timing and the clock timing is compared to a time threshold.

7. The system as defined in claim 1, wherein the synchronization count value is based on the number of received synchronization pulses and the count value is compared to a pulse count.

8. The system as defined in claim 1, wherein the communication bus comprises an externally bussed architecture.

9. The system as defined in claim 1, wherein the communication bus comprises an internally bussed architecture.

10. A method for communicating data in a synchronous communication system having a plurality of devices on a vehicle, said method comprising the steps of:
coupling a control unit to a plurality of devices onboard a vehicle;
communicating synchronization signals from the control unit to each of the plurality of devices via a communication bus;
sensing a parameter with each of the devices and generating a sensed output with each of the devices;
comparing the sensed output of each device to a threshold;
transmitting sensed data from one device to the control unit in response to receipt of the synchronization signal when the sensed output exceeds the threshold;
comparing at least one of a time period and a synchronization count to a count value; and
transmitting a message from the one device to the control unit when at least one of the time period and the synchronization count exceeds the count value.

11. The method as defined in claim 10 further comprising the step of not transmitting a message from the one device to the control unit when the sensed output does not exceed the threshold and the at least one of the time period and synchronization count does not exceed the count value.

12. The method as defined in claim 10, wherein the plurality of devices comprise a plurality of sensors.

13. The method as defined in claim 12, wherein the sensors comprise one or more accelerometers.

14. The method as defined in claim 12, wherein the sensors comprise one or more pressure sensors.

15. The method as defined in claim 12, wherein the sensors comprise crash sensors for use on a crash safety system.

16. The method as defined in claim 10, wherein the time period is based on a clock generator and the count value comprise a time count.

17. The method as defined in claim 10, wherein the synchronization count comprises a count of synchronization signals received and the count value comprises a pulse count.

18. The method as defined in claim 10, wherein the devices communicate with the control unit via an externally bussed architecture.

19. The method as defined in claim 10, wherein the devices communicate with the control unit via an internally bussed architecture.
